(19) United States
(12) Patent Application Publication
(10) Pub. No.: US 2026/0252020 A1
(43) Pub. Date: Aug. 27, 2026

(54) MEDIUM PROCESSING APPARATUS AND SYSTEM INCORPORATING SAME

(71) Applicant: Koh YASUI, Aichi (JP)

(72) Inventor: Koh YASUI, Aichi (JP)

(73) Assignee: ETRIA CO, LTD., Yokohama (JP)

(21) Appl. No.: 19/532,652

(22) Filed: Feb. 6, 2026

(30) Foreign Application Priority Data
Feb. 27, 2025 (JP) 2025-030452

(51) Int. Cl. G03G 15/00; G06K 15/16

(52) U.S. Cl. CPC G03G 15/6552; G06K 15/16; G03G 2215/00561; G03G 2215/00721; G03G 2215/00734; G03G 2215/00759

(57) ABSTRACT

A medium processing apparatus including a sheet tray, a sheet aligner, and circuitry. The sheet tray stacks a sheet bundle including a sheet on which an image is formed. The sheet aligner conveys the sheet on the sheet tray in a given direction, and aligns the sheet on the sheet tray. The circuitry is to control the sheet aligner according to a driving amount of the sheet aligner estimated based on sheet information related to the sheet and image forming information including color information of the image on the sheet.

### CROSS-REFERENCE TO RELATED APPLICATION

This patent application is based on and claims priority pursuant to 35 U.S.C. § 119(a) to Japanese Patent Application No. 2025-030452, filed on Feb. 27, 2025, in the Japan Patent Office, the entire disclosure of which is hereby incorporated by reference herein.

### BACKGROUND

### Technical Field

Embodiments of the present disclosure relate to a medium processing apparatus and a system incorporating the medium processing apparatus.

### Related Art

In systems including an image forming apparatus and a medium processing apparatus, a sheet medium (referred to as “sheet” below) conveyed from the image forming apparatus to the medium processing apparatus is aligned to adjust the position of the sheet in a process tray before a given process is performed on the sheet in the medium processing apparatus. For example, a post-processing apparatus in the art changes the amount of movement of a sheet when aligning the sheet on a staple tray, based on document information.

However, in the post-processing apparatus in the art, when the amount of movement of the sheet is changed, color information of an image formed on the sheet is not taken into consideration.

The ease of aligning a sheet varies depending on the dominant color in an image formed on the sheet. For this reason, for example, a sheet bundle on which a binding process is performed as a post-processing operation had an inconvenience where the position of each sheet of the sheet bundle varies, resulting in an uneven side face of the sheet bundle.

### SUMMARY

Embodiments of the present disclosure described herein provide a novel medium processing apparatus including a sheet tray, a sheet aligner, and circuitry. The sheet tray stacks a sheet bundle including a sheet on which an image is formed. The sheet aligner conveys the sheet on the sheet tray in a given direction, and aligns the sheet on the sheet tray. The circuitry is to control the sheet aligner according to a driving amount of the sheet aligner estimated based on sheet information related to the sheet and image forming information including color information of the image on the sheet.

Further, embodiments of the present disclosure described herein provide a system including a medium processing apparatus and a second apparatus. The medium processing apparatus includes a sheet tray and a sheet aligner. The sheet tray stacks a sheet bundle including a sheet on which an image is formed. The sheet aligner conveys the sheet on the sheet tray in a given direction, and aligns the sheet on the sheet tray. The second apparatus is communicably coupled to the medium processing apparatus. The second apparatus includes circuitry to estimate a driving amount of the sheet aligner, based on sheet information related to the sheet and image forming information including color information of an image formed on the sheet, and control the sheet aligner based on the driving amount estimated in advance.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a system according to a first embodiment of the present disclosure;

FIG. 2 is a diagram illustrating the configuration of a medium processing apparatus of a medium processing apparatus according to an embodiment of the present disclosure;

FIG. 3 is a block diagram illustrating a hardware configuration of a medium processing apparatus, mainly related to sheet alignment;

FIG. 4 including FIGS. 4A, 4B and 4C is a diagram illustrating movement of a tapping roller;

FIG. 5 is a diagram illustrating a table including conditions in which sheets are easy to be aligned and conditions in which sheets are difficult to be aligned;

FIG. 6 is a diagram illustrating areas;

FIG. 7 is a diagram illustrating coverages depending on areas;

FIG. 8 is a diagram illustrating the relation of a medium processing apparatus and a trained model;

FIG. 9 is a diagram illustrating the relation of a control over a tapping roller and a trained model;

FIG. 10 is a flowchart of an adjustment process of a lowering time of a tapping roller shaft;

FIG. 11 is a flowchart of a variable control of the lowering time of a tapping roller shaft based on a trained model;

FIG. 12 is a diagram illustrating a table of the items of training data;

FIG. 13 is a diagram illustrating an overall configuration of a system according to a second embodiment of the present disclosure;

FIG. 14 is a diagram illustrating an overall configuration of a system according to a third embodiment of the present disclosure;

FIGS. 15A and 15B are diagrams illustrating a detection of a sheet by a distance measurement sensor; and

FIG. 16 is a diagram illustrating the relation of the detection result of a distance measurement sensor and the application of new information to a trained model.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### First Embodiment of System

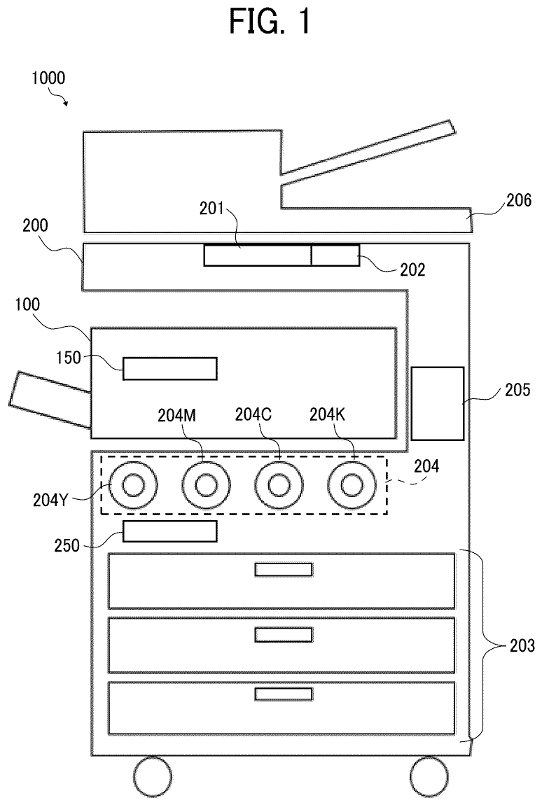

FIG. 1 is a diagram illustrating the overall configuration of a system 1000 according to a first embodiment of the present disclosure.

The system 1000 includes an image forming apparatus 200 and a medium processing apparatus 100. The image forming apparatus 200 forms an image on a sheet as a type of a sheet medium, by typical electrophotography, for example, and includes a display 201, a control panel 202, a sheet feeding device 203, an image forming device 204, a fixing device 205, a document reading device 206, and a controller 250. The image forming method applicable to the image forming apparatus 200 is not limited to the method using electrophotography, and any other image forming methods may be applicable to the image forming apparatus 200.

In the present embodiment, a sheet-shaped medium (sheet medium) to be processed in the system 1000 is assumed to be a sheet of “paper.” However, the object to be processed in the system 1000 according to the present embodiment is not limited to a sheet of paper. For example, any material or specification may be used as long as an image can be formed on a medium in a typical image forming process and the medium is a target of the image forming process. Examples of the medium include a medium that can be an object of a process performed in the medium processing apparatus 100, and the material and specification of the medium are not limited to any particular material and specification.

The display 201 displays screens for outputting a notification to a user of states of various functions and operation contents on a liquid crystal panel. The control panel 202 includes various switch buttons and a keyboard, and is used by the user when setting, for example, the image formation mode, the processing mode for the sheet, and the number of copies. The display 201 and the control panel 202 may be a touch panel. The sheet feeding device 203 accommodates multiple sheets to be separated and fed one by one.

The image forming device 204 includes multiple image forming units 204Y, 204M, 204C and 204K. For example, in a case where an image is formed by an electrophotographic process, the image forming unit 204Y forms a yellow (Y) toner image with yellow toner, and the image forming unit 204M forms a magenta (M) toner image with magenta toner. The image forming unit 204C forms a cyan (C) toner image with cyan toner, and the image forming unit 204K forms a black (K) toner image with black toner. The sheet fed from the sheet feeding device 203 have toner images formed by each of the image forming units 204Y, 204M, 204C and 204K transferred onto the sheet to create a composite toner image.

The toner image formed by the image forming device 204 is transferred onto the sheet fed from the sheet feeding device 203, and is conveyed to the fixing device 205. The fixing device 205 heats and presses the sheet with the toner image to fix the toner image to the sheet. The document reading device 206 reads an original document for forming an image. The controller 250 controls the entire operation of the image forming apparatus 200. The image forming apparatus 200 also serves as an example of a “different apparatus” or “another apparatus” according to the present disclosure.

The medium processing apparatus 100 is disposed in the body of the image forming apparatus 200 (i.e., a space formed between the image forming device 204 and the document reading device 206) and performs a process that is set in advance on the sheet received from the fixing device 205. The medium processing apparatus 100 includes a controller 150 as a controller. The controller 150 is communicably connected to the controller 250 of the image forming apparatus 200. The controller 150 controls the rotation of each roller in the medium processing apparatus 100, the movement of a jogger 112, and the operation of a stapler 113, based on instructions from the controller 250, for example, to perform a binding process on the sheet.

### Configuration of Medium Processing Apparatus 100

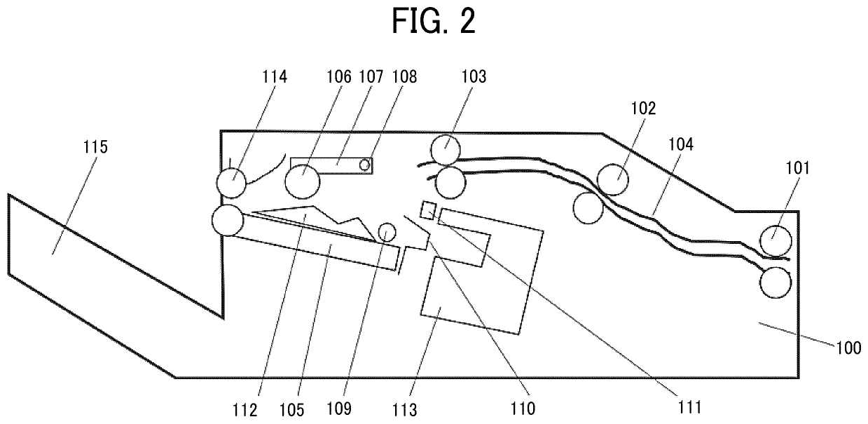

FIG. 2 is a block diagram illustrating the medium processing apparatus 100.

A sheet conveyed from the fixing device 205 of the image forming apparatus 200 is conveyed by an entrance roller pair 101 to be received by the medium processing apparatus 100. The sheet is then conveyed by a conveyance roller pair 102 and a shift roller pair 103 along a conveyance path 104. The sheet that has reached the shift roller pair 103 is ejected by a shift roller pair 103 onto a staple tray 105. When the sheet is ejected on the staple tray 105, a tapping roller shaft 107 causes a tapping roller rotary shaft 108 to lower as a rotary shaft, so that the tapping roller 106 descends to the position where the tapping roller 106 contacts the sheet. The tapping roller 106 is an example of a “sheet aligner” according to the present disclosure.

The tapping roller 106 is driven to rotate to descend to the position where the tapping roller 106 contacts the sheet. At the moment the tapping roller 106 contacts the sheet, the tapping roller 106 conveys the sheet in the sub-scanning direction (i.e., a direction orthogonal to the width direction of the sheet) as a given direction. A return roller 109 is disposed above the staple tray 105 and is in contact with the staple tray 105 while being driven and rotated. As the tapping roller 106 conveys the sheet to a position between the staple tray 105 and the return roller 109, the sheet is also assisted by the return roller 109 to be conveyed in the sub-scanning direction. The tapping roller 106 and the return roller 109 convey the sheet until the leading end of the sheet in the sheet conveyance direction contacts a reference fence 110.

The position of the sheet with respect to the reference fence 110 is detected by, for example, a distance measurement sensor 111 as a sheet detector disposed in the vicinity of the reference fence 110. When the sheet reaches the reference fence 110, the sheet is aligned in the main scanning direction (i.e., the width direction of the sheet) by the jogger 112, and then the binding process is performed by the stapler 113. The sheet subjected to the binding process is ejected by an ejection roller pair 114 to an ejection tray 115.

### Hardware Configuration of Medium Processing Apparatus 100

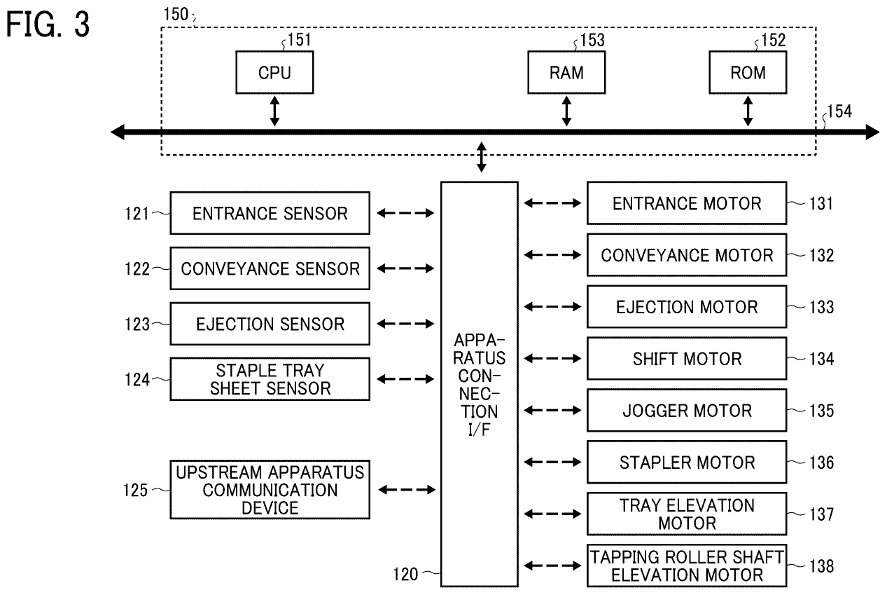

FIG. 3 is a block diagram illustrating an example of the hardware configuration related to sheet alignment mainly of the medium processing apparatus 100.

The controller 150 of the medium processing apparatus 100 includes a central processing unit (CPU) 151, a read-only memory (ROM) 152, a random access memory (RAM) 153, and a bus line 154.

Among those components, the CPU 151 is an arithmetic device that executes the computer-readable program that executes the entire control of the medium processing apparatus 100 and is stored in the ROM 152 so as to execute, for example, processing of sequence, selection, and repetition. The CPU 151 can also serve as the “estimation unit” in the present disclosure. In that case, the CPU 151 has the function of estimating the amount of driving force of the tapping roller 106 as a sheet aligner.

The ROM 152 is a nonvolatile storage device that stores programs and data executed by the CPU 151.

The RAM 153 is a memory that stores data temporarily when the CPU 151 executes the program, and is used as, for example, a work area for the CPU 151. The bus line 154 is, e.g., an address bus or a data bus to electrically connect the components to each other.

Further, the controller 150 is electrically connected to multiple sensors (such as an entrance sensor 121, a conveyance sensor 122, an ejection sensor 123, and a staple tray sheet sensor 124) and an upstream apparatus communication device 125 to each other, via an apparatus connection interface (I/F) 120. Further, the controller 150 is electrically connected to multiple motors (such as an entrance motor 131, a conveyance motor 132, an ejection motor 133, a shift motor 134, a jogger motor 135, a staple motor 136, a tray elevation motor 137, and a tapping roller shaft elevation motor 138) to each other, via an apparatus connection I/F 120.

The upstream apparatus communication device 125 is an interface to communicate with the controller 250 of the image forming apparatus 200, and exchanges data to be used for control associated with the execution of the process, between the image forming apparatus 200 and the medium processing apparatus 100.

### Sheet Alignment Operation

Then, a detailed description is given of the sheet alignment in which the tapping roller 106 aligns a sheet P as a sheet.

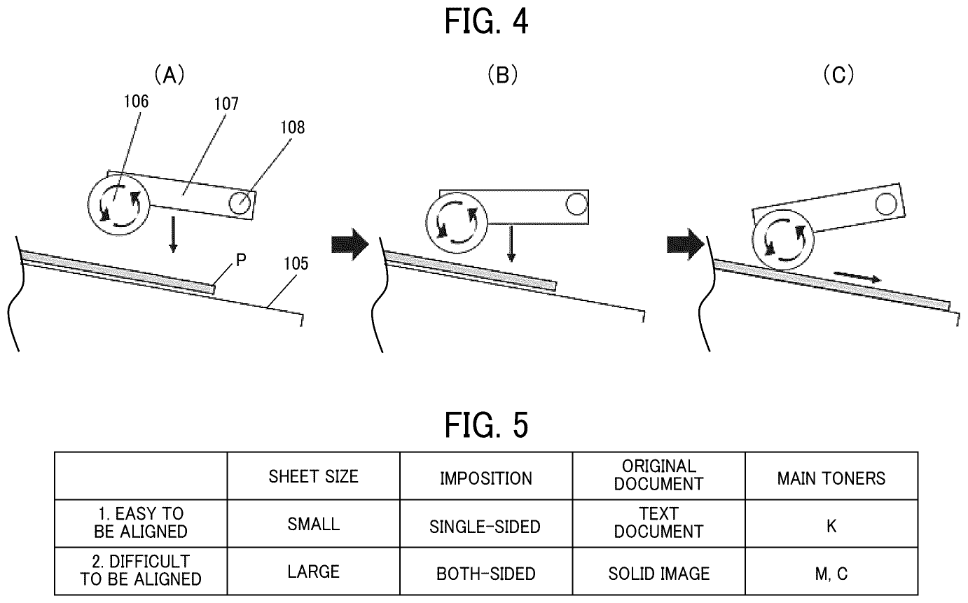

FIG. 4 including FIGS. 4A, 4B and 4C is a diagram illustrating a movement of a tapping roller 106.

The tapping roller shaft 107 is controlled by the tapping roller shaft elevation motor 138 to be raised or lowered (elevated). The tapping roller shaft 107 is raised or lowered along with rotation of the tapping roller rotary shaft 108. The tapping roller 106 is controlled by the conveyance motor 132 to be rotated. Before the alignment with respect to the sheet P starts, the tapping roller 106 is driven and rotated as illustrated in FIG. 4A. However, the tapping roller shaft 107 is raised, and the tapping roller 106 is not in contact with the sheet P. When aligning the sheet P, as illustrated in FIG. 4B, the tapping roller shaft 107 is lowered while the tapping roller 106 is being driven and rotated. Then, as illustrated in FIG. 4C, the tapping roller 106 contacts the sheet P above the staple tray 105. Due to this operation, the sheet P is conveyed toward the reference fence 110 to be aligned, in other words, the position of the leading end of the sheet P is aligned.

Due to the above-described configuration, the tapping roller 106 is at the position corresponding to the lowering time of the tapping roller shaft 107, in other words, the position where the tapping roller shaft 107 is lowered. As the time the tapping roller 106 is in contact with the staple tray 105 increases, the time to align the sheets P also increases, which makes it easier to align the sheets P. In the present embodiment, there may be a case where the terms including the “lowering time” such as the “lowering time of the tapping roller 106” or the “lowering time of the tapping roller shaft 107” are used. As described above, the term the “lowering time” refers to the time when the tapping roller 106 is at the position to contact the staple tray 105 or the time when the tapping roller 106 is at the position to contact the sheets P on the staple tray 105.

However, the time to align the sheets P are not constant, and there are conditions that are easy to align and conditions that are difficult to align, depending on the content of the image formation settings.

A description is given of the above-described conditions, with reference to FIG. 5.

FIG. 5 is a diagram illustrating a table including conditions in which sheets are easy to be aligned and conditions in which sheets are difficult to be aligned.

The description of the ease of aligning the sheet is given on each condition.

First, regarding sheet size, it is easy to align small-size sheets while it is difficult to align large-size sheets since the large-size sheets are heavier than the small-size sheets. In imposition, it is easy to align the sheets for single-sided output while it is difficult to align the sheets for both-sided output since the output sides tend to overlap when the sheets are stacked.

Regarding document types, it is easy to align text documents while it is difficult to align solid image documents since because the surfaces of the solid image documents tend to stick. Further, such alignment of documents can be easy or difficult depending on the type of toner. In other words, when the tint of the toner primarily used for image formation is K (black), the alignment of the documents tends to be easy. However, when the tint of the toner primarily used for image formation is M (magenta) or C (cyan), the alignment of the documents tends to be difficult since the output surfaces of the documents tends to stick to the sheet more easily, resulting in a more difficult alignment. The fact that M (magenta) toner and C (cyan) toner are easier to adhere to a sheet when compared with K (black) toner is based on evaluations using specified types of toner. However, in a case where the toner material or manufacturing method is different, the result may have different tendencies. For convenience, this specification of the present disclosure provides, for convenience, an explanation that sheets on which toner images are formed with black toner tend to be easier to align than sheets on which toner images are formed with magenta toner and cyan toner, since the sheets with black toner are less likely to stick to each other.

The above tendency has been confirmed in evaluation experiments conducted by the inventors, and in particular, the copies made with M toner and C toner tend to adhere to the sheet more easily immediately after image formation. Further, the rank (relation) of the ease of adherence of toner to sheet is represented as (M toner or C toner)>K toner. Further, the rank (relation) of combination of the ease of adherence of toner to sheet is represented as combination of M toners or C toners >combination of (M toner or C toner) and K toner>combination of K toners.

Further, even with solid image, the difficulty of sheet alignment may vary depending on whether the solid part of the sheet is concentrated (coverage by area).

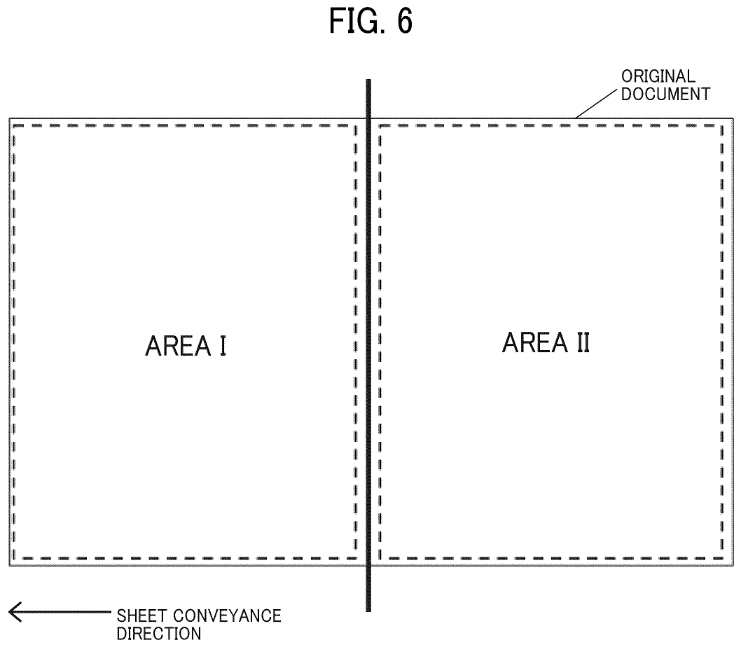

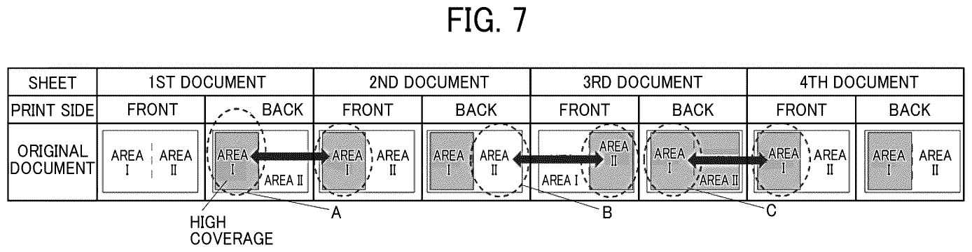

A description is given below of details of the coverage by area, with reference to FIGS. 6 and 7.

FIG. 6 is a diagram illustrating Area I and Area II.

FIG. 7 is a diagram illustrating coverages by area.

For example, as illustrated in FIG. 6, a single original document is divided into Area I and Area II, the coverage for each area is read, and the ease of alignment is determined based on the coverage for each area of an original document and a subsequent original document.

As a premise, when aligning the sheets of the N-th document in the staple tray 105, Area I of the front face of the N-th document overlaps with Area I of the back face of the N−1th document, and Area II of the front face of the N-th document overlaps with Area II of the back face of the N−1th document. Due to such a situation, when the high coverage portions of Area I and Area II overlaps, it is difficult to align the sheet (document).

FIG. 7 is an example of the difficulty of the sheet alignment.

When the second document is aligned, Area I of the front face of the second document has high coverage while Area I of the back face of the first document that is overlapped with the second document has high coverage (part A of FIG. 7).

For this reason, the sheet alignment of the second document is difficult.

Then, when focusing on the third document, the front face of the third document has high coverage in Area II. However, Area II of the back face of the second document that is overlapped with the third document does not have high coverage (part B of FIG. 7). For this reason, the sheet alignment of the third document is easy.

Then, when focusing on the fourth document, the front face of the fourth document has high coverage in Area II. In addition, Area I of the back face of the third document that is overlapped with the fourth document also has high coverage (part C of FIG. 7). For this reason, the sheet alignment of the fourth document is difficult.

The above-described examples have two divisions of the coverage. However, the number of divisions of the coverage is not limited to the above-identified examples. For example, the coverage may be divided in three or more divisions. As the number of divisions of the coverage by area increases, the accuracy of identifying the dense of the solid part can be more enhanced.

### Estimation of Amount of Driving Force for Tapping Roller 106

The medium processing apparatus 100 with the above-described configuration estimates the amount of driving force for the tapping roller 106 as a sheet aligner, based on sheet information regarding the sheets to be ejected to the staple tray 105 as a process tray and image formation information that includes the color information of the images formed on the sheets to be ejected to the staple tray 105, and controls the tapping roller 106 based on the estimated amount of driving force. The amount of driving force of the tapping roller 106 corresponds to the lowering time of the tapping roller 106 or the tapping roller shaft 107. In other words, a larger amount of driving force for the tapping roller 106 corresponds to a longer lowering time for the tapping roller 106 or the tapping roller shaft 107, in other words, the tapping roller 106 contacts the staple tray 105 or the sheet placed on the staple tray 105 for a longer time. The amount of driving force of the tapping roller 106 is estimated using a trained model 500 that is generated by the machine learning.

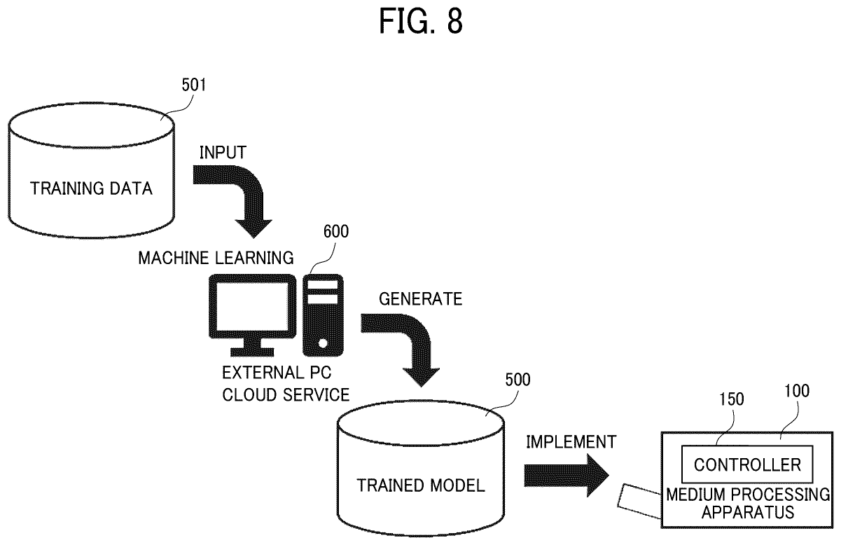

FIG. 8 is a diagram illustrating the relation of the medium processing apparatus 100 and the trained model 500.

The trained model 500 corresponds to a trained model generated by the machine learning process based on training data 501 as input data that is input to an external personal computer (external PC) 600 that can generate the trained model 500 (or cloud service). The trained model 500 is generated by analyzing the training data 501, making it possible to perform analysis, estimation, and prediction processes on new input data. The training data 501 is data created based on a collection of data obtained from evaluation experiments during the design of the medium processing apparatus 100. The trained model 500 generated by machine learning is a kind of calculation algorithm, and is implemented as a module as a part of a control program to, for example, the controller 150 (i.e., the ROM 152) of the medium processing apparatus 100.

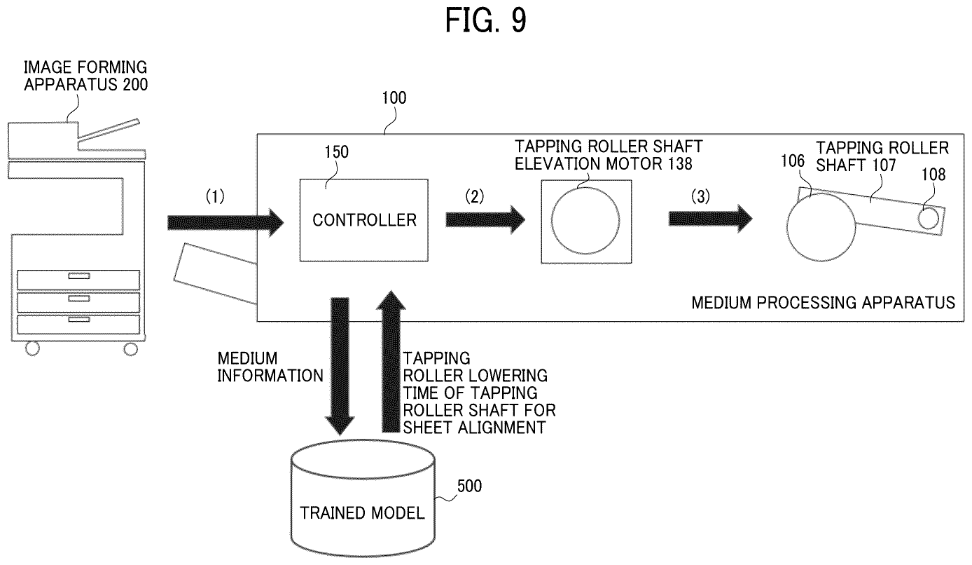

FIG. 9 is a diagram illustrating the relation of a control over the tapping roller 106 and the trained model 500, indicating the control that varies the lowering time of the tapping roller shaft 107 based on document information received from the image forming apparatus 200.

In FIG. 9, the controller 150 of the medium processing apparatus 100 receives information about the type of original document and sheet from the image forming apparatus 200. This information includes sheet information related to the sheet size and image formation information such as imposition, original document (text/solid), coverage for each area, and the color of toner primarily used for image formation. The controller 150 compares the information received from the image forming apparatus 200 with the trained model 500. Then, the controller 150 acquires the information of the lowering time of the tapping roller shaft 107 for alignment. The controller 150 controls the tapping roller shaft elevation motor 138 based on the information required via the trained model 500, so as to lower the tapping roller shaft 107. Accordingly, the tapping roller 106 contacts the sheet on the staple tray 105 at the optimum time, to align the sheet.

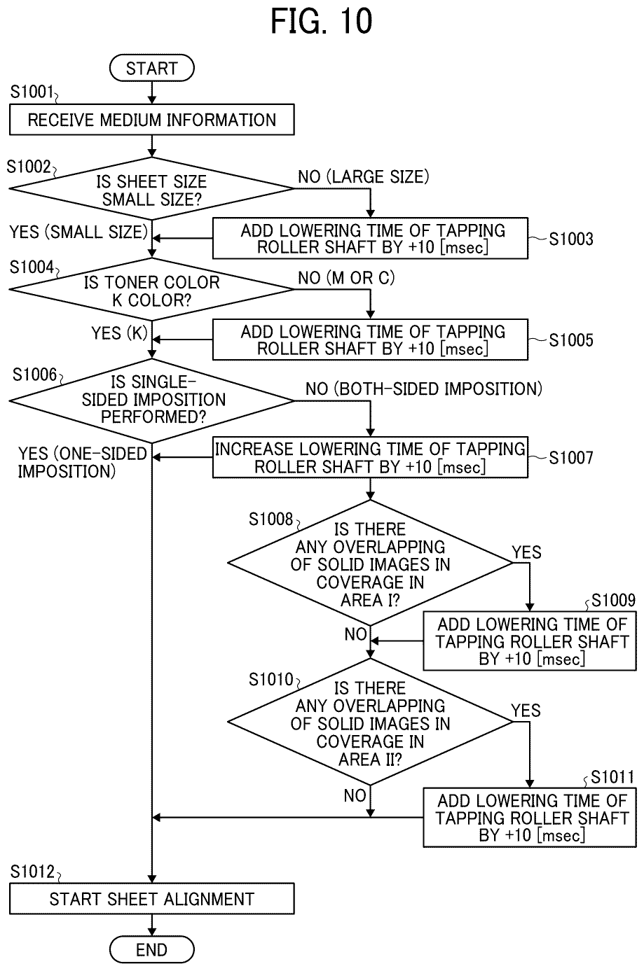

FIG. 10 is a flowchart of an adjustment process of the lowering time of the tapping roller shaft 107.

In the present embodiment, the document is divided into Area I and Area II, and the coverage by area of Area I and Area II is also used as a source of data for the lowering time of the tapping roller shaft 107.

The start of this process is triggered by the start of image formation (print). For example, the controller 150 of the medium processing apparatus 100 receives medium information such as document information (or sheet information) in step S1001. The controller 150 determines whether the sheet size is a small size (or a large size) based on the received document information (or sheet information) in step S1002. When the sheet size is determined as a small size in step S1002 (YES in step S1002), the controller 150 maintains the value of the lowering time of the tapping roller shaft 107 as the default value. On the other hand, when the sheet size is determined as a large size in step S1002 (NO in step S1002), the controller 150 adds +10 msec to the default value of the lowering time of the tapping roller shaft 107 in step S1003.

Then, the controller 150 determines the color information of the toner primarily used for image formation in step S1004. In other words, the controller 150 determines whether the toner color is “K (black) color” in step S1004. When the color of the toner primarily used for image formation is determined to be “K (black color)” (YES in step S1004), the controller 150 maintains the value of the lowering time of the tapping roller shaft 107 at the value set in step S1002. When the color of the toner primarily used for image formation is determined to be “M (magenta) color or C (cyan) color”, the controller 150 adds +10 msec to the value of the lowering time of the tapping roller shaft 107 set in step S1002, in step S1005.

Then, the controller 150 determines the imposition information in step S1006. In other words, the controller 150 determines whether single-sided imposition is performed in step S1006. When it is determined that the single-sided imposition (output) is performed in step S1006 (YES in step S1006), the controller 150 maintains the value of the lowering time of the tapping roller shaft 107 at the value set in step S1004. Then, the controller 150 starts the sheet alignment using the value of the lowering time of the tapping roller shaft 107 set from step S1002 to step S1006, in step S1012.

When it is determined that the both-sided imposition (output) is performed in step S1006 (NO in step S1006), the controller 150 adds +10 msec to the value of the lowering time of the tapping roller shaft 107 set in step S1004, in step S1007. Further, when the both-sided imposition (output) is performed in step S1006, the controller 150 determines whether the solid images in Area I overlap based on the information of the coverage in Area I in step S1008. In other words, the controller 150 determines whether there is any overlapping of the solid images in the coverage in Area I in step S1008. When it is determined that there is no overlapping of the solid images in the coverage in Area I in step S1008 (NO in step S1008), the controller 150 maintains the value of the lowering time of the tapping roller shaft 107 at the value set up to step S1007. On the other hand, when it is determined that there is any overlapping of the solid images in the coverage in Area I in step S1008 (YES in step S1008), the controller 150 adds +10 msec to the value of the lowering time of the tapping roller shaft 107 that was set up to step S1007, in step S1009.

Similarly, the controller 150 determines whether the solid images in Area II overlap based on the information of the coverage in Area II in step S1010. In other words, the controller 150 determines whether there is any overlapping of the solid images in the coverage in Area II in step S1010. When it is determined that there is no overlapping of the solid images in the coverage in Area II in step S1010 (NO in step S1010), the controller 150 maintains the value of the lowering time of the tapping roller shaft 107 at the value set up to step S1008. Then, the controller 150 starts the sheet alignment using the value of the lowering time of the tapping roller shaft 107 set from step S1002 to step S1010, in step S1012.

On the other hand, when it is determined that there is any overlapping of the solid images in the coverage in Area II in step S1010 (YES in step S1010), the controller 150 adds +10 msec to the value of the lowering time of the tapping roller shaft 107 that was set up to step S1008, in step S1011. Then, the controller 150 starts the sheet alignment using the value of the lowering time of the tapping roller shaft 107 set from step S1002 to step S1011, in step S1012.

Each determination item described in this flowchart is an example, and any determination item may be added or removed appropriately. Further, the order of determination for each determination item and the values of the lowering time of the tapping roller shaft 107 that are added in the determination results for each determination item are not limited to the above-described order of determination or values, and may be changed appropriately. Further, the added value for the lowering time of the tapping roller shaft 107 is not limited to +10 msec, and may be set to various added values different for each determination item.

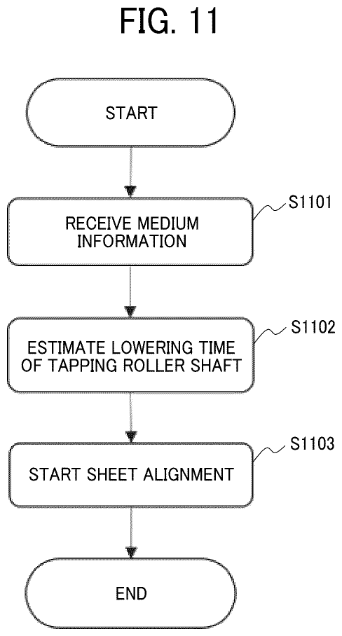

FIG. 11 is a flowchart of a variable control of the lowering time of the tapping roller shaft 107 based on the trained model 500.

The start of this process is triggered by the start of image formation (print). For example, the controller 150 of the medium processing apparatus 100 receives medium information such as document information (or sheet information) from the image forming apparatus 200 in step S1101. The controller 150 estimates the lowering time of the tapping roller shaft 107 for sheet alignment, based on the received document information (or sheet information) and the information of the trained model 500 in step S1102. In other words, the controller 150 estimates the amount of driving force of the tapping roller 106 in step S1102. Based on the estimated lowering time of the tapping roller shaft 107, the controller 150 lowers the tapping roller shaft 107. Accordingly, the tapping roller 106 contacts the sheet on the staple tray 105 at the optimum time, to align the sheet (start sheet alignment) in step S1103.

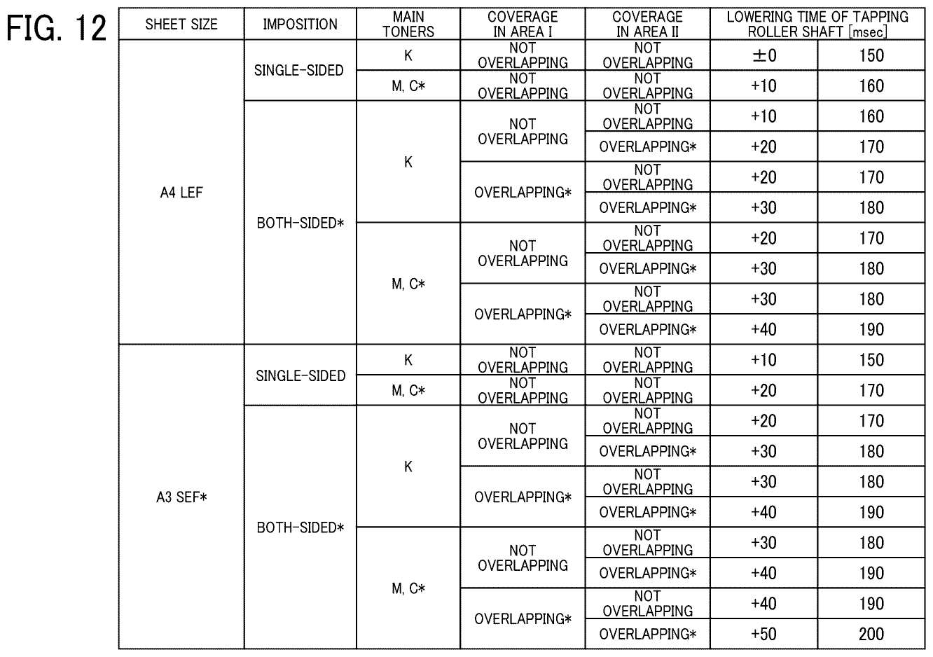

FIG. 12 is a diagram illustrating a table of the items of the training data 501.

In the present embodiment, the sheet size, imposition, toner color primarily used for image formation, and information of coverage by area serve as input data, so that the lowering time of the tapping roller shaft 107 for sheet alignment is estimated. As the number of conditions that are difficult to align sheets (for example, the items marked with an asterisk “*” in the table of FIG. 12) increases, the time to retain the tapping roller shaft 107 lower becomes longer.

The settings of the sheet information related to the sheet size and the image formation information including imposition, coverage for each area, and the color of the toner primarily used for image formation may be performed via the display 201 and the control panel 202 both included in the image forming apparatus 200, and may be acquired by the controller 150 of the medium processing apparatus 100 through the communication with the controller 250 of the image forming apparatus 200. Further, the display 201 and the control panel 202 may be disposed on the medium processing apparatus 100.

### Second Embodiment of System

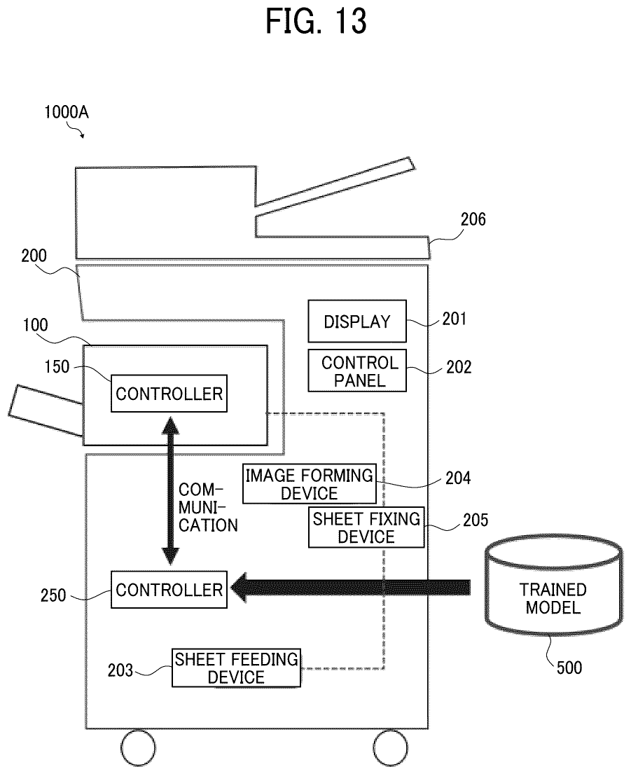

FIG. 13 is a diagram illustrating the overall configuration of a system 1000A according to a second embodiment of the present disclosure.

The system 1000 according to the first embodiment illustrated in FIG. 8 has the configuration in which the trained model 500 is implemented in the controller 150 of the medium processing apparatus 100. On the other hand, the system 1000A according to the second embodiment illustrated in FIG. 13 is different from the system 1000 according to the first embodiment, in which the trained model 500 is implemented in an external system other than the medium processing apparatus 100. This external system includes the image forming apparatus 200 or a different information processing apparatus that is coupled to the medium processing apparatus 100 or the image forming apparatus 200.

For example, the trained model 500 may be stored as a part of the control program written to the controller 250 of the image forming apparatus 200 that communicates with the medium processing apparatus 100, as illustrated in FIG. 13. Typically, the image forming apparatus 200 has a function of setting sheet information and image formation information. Due to such a configuration, the amount of driving force of the tapping roller 106 can be estimated using the sheet information and the image formation information. Alternatively, the trained model 500 may be stored in a different system that is coupled to the image forming apparatus 200. Further, an external system other than the medium processing apparatus 100 may perform up to the estimation of the amount of driving force of the tapping roller 106, and the medium processing apparatus 100 may receive (acquire) the estimation result.

### Third Embodiment of System

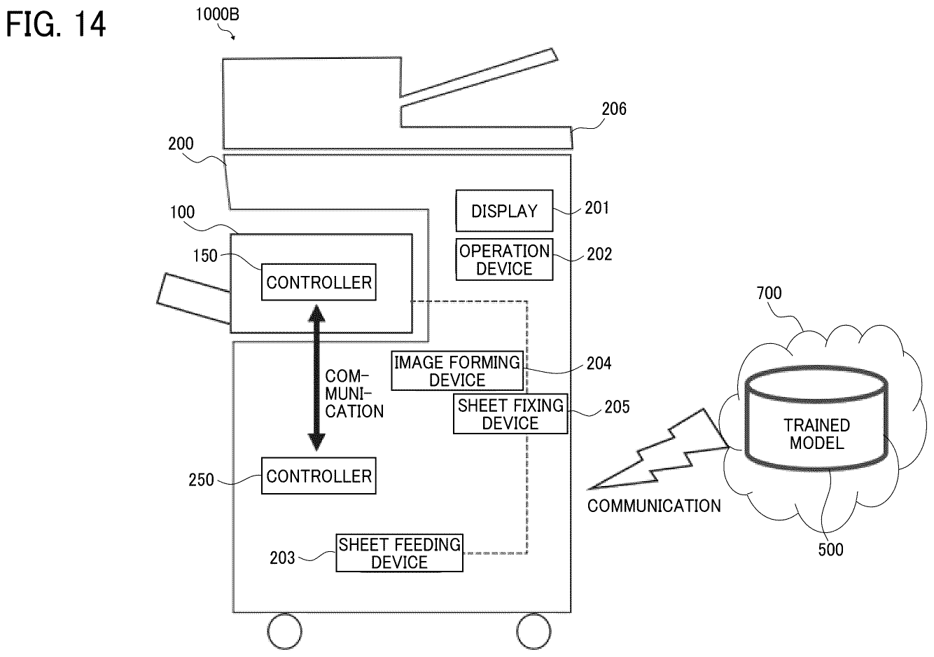

FIG. 14 is a diagram illustrating the overall configuration of a system 1000B according to a third embodiment of the present disclosure.

Like the configuration of the system 1000B according to the third embodiment illustrated in FIG. 14, the trained model 500 may be stored in a cloud system 700, as an information processing apparatus that communicates with the image forming apparatus 200 via network. In this case, the sheet information and the image formation information for estimating the amount of driving force of the tapping roller 106 are sent as data to the cloud system 700, to be estimated on the cloud system 700. Then, the estimation result estimated on the cloud system 700 is received by the image forming apparatus 200, so that the driving of the tapping roller 106 can be controlled based on the estimated amount of driving force of the tapping roller 106.

Alternatively, the trained model 500 may be usually stored in the cloud system 700. The trained model 500 stored in the cloud system 700 may be downloaded at the timing when the power of the image forming apparatus 200 is turned on. In this case, no communication is not to be done between the image forming apparatus 200 and the cloud system 700 at the timing of image formation, and the time from the print job instruction by the user to the print start can be reduced. Further, the communication with the cloud system 700 is not limited to the communication between the image forming apparatus 200 and the cloud system 700. For example, the medium processing apparatus 100 may include a communication module that enables communication with the cloud system 700, so that the medium processing apparatus 100 communicates with the cloud system 700 to estimate the amount of driving force of the tapping roller 106.

Like the configurations of the second embodiment and the third embodiment, the trained model 500 is stored in a system other than the medium processing apparatus 100, for example, the image forming apparatus 200 or the cloud system 700. By so doing, the design freedom (i.e., the degrees in the design) is achieved.

### Distance Measurement Sensor

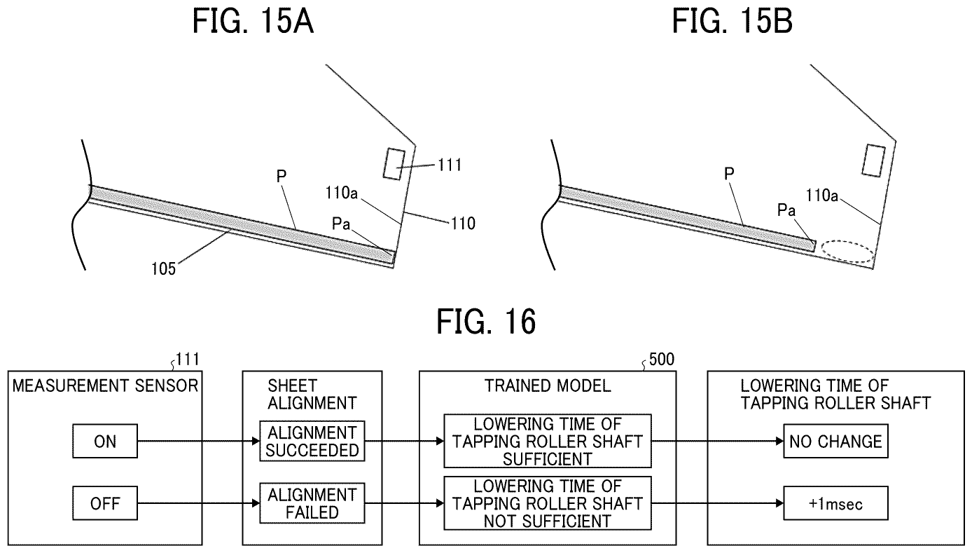

FIGS. 15A and 15B are diagrams illustrating a detection of a sheet by the distance measurement sensor 111.

The distance measurement sensor 111 as a sheet detector is disposed in the vicinity of the reference fence 110 to detect an arrival of the leading end Pa of the sheet P as a sheet medium, when aligning the sheet P with the fence face 110a of the reference fence 110. FIG. 15A illustrates the state where the leading end Pa of the sheet P has reached the fence face 110a of the reference fence 110, indicating that sheet P is properly aligned. FIG. 15B illustrates the state where the leading end Pa of sheet P has not yet reached the fence face 110a of the reference fence 110, indicating that the distance measurement sensor 111 has not yet detected the sheet P.

When a misalignment as illustrated in FIG. 15B occurs even though the drive control is performed on the tapping roller 106 based on the estimated amount of driving force of the tapping roller 106, it is preferable to feedback the detection result of the distance measurement sensor 111 to the training data 501. As the trained model 500 is further trained by using the latest training data 501 to update the trained model 500, the reliability of alignment of the sheet can be enhanced.

FIG. 16 is a diagram illustrating the relation of the detection result of the distance measurement sensor 111 and the application of new information to the trained model 500.

When the sheet is not detected by the distance measurement sensor 111 to be in the state of misalignment, the controller 150, for example, sends a feedback to the training data 501 as information that the lowering time of the tapping roller shaft 107 is insufficient, and performs data construction. Further, as the trained model 500 is further trained by using the latest training data 501, the data of the lowering time of the tapping roller shaft 107 with the time newly added by +1 msec, for example, is added to the trained model 500. As described above, the state of alignment of the sheet can be grasped according to the detection result of the distance measurement sensor 111 and the detection result of the distance measurement sensor 111 is applied to the trained model 500, so that the data of the lowering time of the tapping roller shaft 107, in other words, the amount of driving force of the tapping roller 106 can be enhanced.

The present disclosure is not limited to the above-described embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents.

Such modifications are included in the technical scope described in the scope of claims.

### Aspects of the Present Disclosure

Aspects of the present disclosure are, for example, as follows.

### Aspect 1

In Aspect 1, a medium processing apparatus includes a sheet aligner to convey a sheet ejected to a process tray in a given direction to align the sheet, and a controller to control the sheet aligner according to a driving amount of the sheet aligner estimated based on sheet information related to the sheet, and image forming information including color information of an image formed on the sheet.

### Aspect 2

In Aspect 2, the medium processing apparatus according to Aspect 1 further includes an estimation unit to estimate the driving amount.

### Aspect 3

In Aspect 3, in the medium processing apparatus according to Aspect 2, the estimation unit includes a trained model generated by machine learning using training data associating the sheet information, the image forming information, and the driving amount.

### Aspect 4

In Aspect 4, the medium processing apparatus according to Aspect 3 further includes a sheet detector to detect the position of the sheet to be conveyed in the given direction by the sheet aligner. The estimation unit is further to feed back a detection result of the sheet detector to the training data, and update the trained model.

### Aspect 5

In Aspect 5, in the medium processing apparatus according to any one of Aspects 1 to 4, the sheet information includes sheet size information.

### Aspect 6

In Aspect 6, in the medium processing apparatus according to any one of Aspects 1 to 5, the image forming information includes at least one of imposition, document type, or document coverage per area.

### Aspect 7

In Aspect 7, a system includes a medium processing apparatus and a different apparatus. The medium processing apparatus includes a sheet tray and a sheet aligner. The sheet tray is a tray to which a sheet is ejected. The sheet aligner conveys the sheet in a given direction, and aligns the sheet. The different apparatus is communicably coupled to the medium processing apparatus, and includes circuitry. The circuitry is to estimate a driving amount of the sheet aligner, based on sheet information related to the sheet, and image forming information including color information of an image formed on the sheet, and control the sheet aligner based on the driving amount estimated in advance.

### Aspect 8

In Aspect 8, in the system according to Aspect 7, the different apparatus is an image forming apparatus to form an image on the sheet.

### Aspect 9

In Aspect 9, in the system according to Aspect 7, the different apparatus is an information processing apparatus.

### Aspect 10

In Aspect 10, a medium processing apparatus includes a sheet tray, a sheet aligner, and circuitry. The sheet tray stacks a sheet bundle including a sheet on which an image is formed. The sheet aligner conveys the sheet on the sheet tray in a given direction, and aligns the sheet on the sheet tray. The circuitry is to control the sheet aligner according to a driving amount of the sheet aligner estimated based on sheet information related to the sheet and image forming information including color information of the image on the sheet.

### Aspect 11

In Aspect 11, in the medium processing apparatus according to Aspect 10, the circuitry is further to estimate the driving amount based on the sheet information and the image forming information.

### Aspect 12

In Aspect 12, in the medium processing apparatus according to Aspect 11, the circuitry is further to implement a trained model generated by machine learning using training data associating the sheet information, the image forming information, and the driving amount.

### Aspect 13

In Aspect 13, the medium processing apparatus according to Aspect 12 further includes a sheet detector to detect a leading end of the sheet conveyed in the given direction by the sheet aligner on the sheet tray. The circuitry is further to feedback a detection result of the sheet detector to the training data, and update the trained model.

### Aspect 14

In Aspect 14, in the medium processing apparatus according to any one of Aspects 10to 13, the circuitry is further configured to control the sheet aligner according to the driving amount of the sheet aligner estimated based on the sheet information including a size of the sheet.

### Aspect 15

In Aspect 15, in the medium processing apparatus according to any one of Aspects 10to 14, the image forming information includes at least one of imposition, document type, or document coverage per area.

### Aspect 16

In Aspect 16, a system includes a medium processing apparatus and a different apparatus. The medium processing apparatus includes a sheet tray and a sheet aligner. The sheet tray stacks a sheet bundle including a sheet on which an image is formed. The sheet aligner conveys the sheet on the sheet tray in a given direction, and aligns the sheet on the sheet tray. The second apparatus is communicably coupled to the medium processing apparatus. The second apparatus includes circuitry configured to estimate a driving amount of the sheet aligner, based on sheet information related to the sheet and image forming information including color information of an image formed on the sheet, and control the sheet aligner based on the driving amount estimated in advance.

### Aspect 17

In Aspect 17, in the system according to Aspect 16, the second apparatus is an image forming apparatus to form an image on the sheet.

### Aspect 18

In Aspect 18, in the system according to Aspect 16, the second apparatus is an information processing apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a sheet tray to stack a sheet bundle including a sheet on which an image is formed;
a sheet aligner to:
convey the sheet on the sheet tray in a given direction; and
align the sheet on the sheet tray; and
circuitry configured to:
control the sheet aligner according to a driving amount of the sheet aligner estimated based on:
sheet information related to the sheet; and
image forming information including color information of the image on the sheet.

2. The medium processing apparatus according to claim 1,
wherein the circuitry is further configured to estimate the driving amount based on the sheet information and the image forming information.

3. The medium processing apparatus according to claim 2,
wherein the circuitry is further configured to implement a trained model generated by machine learning using training data associating:
the sheet information;
the image forming information; and
the driving amount.

4. The medium processing apparatus according to claim 3, further comprising:
a sheet detector to detect a leading end of the sheet conveyed in the given direction by the sheet aligner on the sheet tray,
wherein the circuitry is further configured to:
feedback a detection result of the sheet detector to the training data; and
update the trained model.

5. The medium processing apparatus according to claim 1,
wherein the circuitry is further configured to control the sheet aligner according to the driving amount of the sheet aligner estimated based on the sheet information including a size of the sheet.

6. The medium processing apparatus according to claim 1,
wherein the image forming information includes at least one of imposition, document type, or document coverage per area.

7. A system comprising:
a medium processing apparatus including:
a sheet tray to stack a sheet bundle including a sheet on which an image is formed;
a sheet aligner to:
convey the sheet on the sheet tray in a given direction; and
align the sheet on the sheet tray; and
a second apparatus communicably coupled to the medium processing apparatus,
the second apparatus including:
circuitry configured to:
estimate a driving amount of the sheet aligner, based on:
sheet information related to the sheet; and
image forming information including color information of an image formed on the sheet; and
control the sheet aligner based on the driving amount estimated in advance.

8. The system according to claim 7,
wherein the second apparatus is an image forming apparatus to form an image on the sheet.

9. The system according to claim 7,
wherein the second apparatus is an information processing apparatus.
